(19) United States
(12) Patent Application Publication
(10) Pub. No.: US 2015/0175010 A1
(43) Pub. Date: Jun. 25, 2015

(54) ALL-WHEEL DRIVE ELECTRIC VEHICLE MOTOR TORQUE SAFETY MONITOR

(71) Applicant: Atieva, Inc., Redwood City, CA (US)

(72) Inventor: Yifan TANG, Redwood City, CA (US)

(73) Assignee: Atieva, Inc., Redwood City, CA (US)

(21) Appl. No.: 14/194,527

(22) Filed: Feb. 28, 2014

Related U.S. Application Data
(63) Continuation-in-part of application No. 13/948,307, filed on Jul. 23, 2013.

(51) Int. Cl. B60L 3/12

(52) U.S. Cl. CPC B60L 3/12

(57) ABSTRACT

A vehicle torque safety monitor is provided. The safety monitor includes a vehicle power estimator configured to estimate a first mechanical power of a first electric motor and a second mechanical power of a second electric motor. The safety monitor includes an energy storage system power estimator and limiter, configured to estimate electrical power provided by an energy storage system, at least a portion of the electrical power converting to the first mechanical power and the second mechanical power. The system includes a vehicle power monitor, configured to indicate an inconsistency in the first mechanical power, the second mechanical power, and the electrical power.

This application is a continuation in part (CIP) of, and claims benefit of priority from, U.S. Nonprovisional application Ser. No. 13/948,307, titled “ELECTRIC VEHICLE MOTOR TORQUE SAFETY MONITOR”, filed Jul. 23, 2013, which is hereby incorporated by reference.

### BACKGROUND

Motor controls for electric and hybrid vehicles are complex systems. All-wheel drive vehicles are generally more complex than front-wheel drive or rear-wheel drive vehicles. Any sufficiently complex system can undergo failure from a variety of causes. Many modern automobiles have a black box recorder, which records data during operation of the automobile. These black boxes can be used to diagnose failure after the fact. Many modern automobiles have onboard diagnostics, which can diagnose failure of a component or a system during operation of the automobile. Yet, because electric and hybrid vehicle systems are still relatively new, there is a need in the art for a solution which improves upon previously available monitoring and diagnostic systems.

### SUMMARY

A vehicle torque safety monitor is provided in some embodiments. The safety monitor includes a vehicle power estimator configured to estimate a first mechanical power of a first electric motor and a second mechanical power of a second electric motor. The safety monitor includes an energy storage system power estimator and limiter, configured to estimate electrical power provided by an energy storage system, at least a portion of the electrical power converting to the first mechanical power and the second mechanical power. The system includes a vehicle power monitor, configured to indicate an inconsistency in the first mechanical power, the second mechanical power, and the electrical power. A vehicle control unit and a method of monitoring power in an all-wheel drive vehicle having a plurality of electric motors are also provided.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a schematic diagram of an all-wheel drive electric vehicle motor control system, with motor drive units, in accordance with some embodiments.

FIG. 1B is a schematic diagram of the driver interface of the all-wheel drive electric vehicle motor control system of FIG. 1A, in accordance with some embodiments.

FIG. 1C is a schematic diagram of the vehicle control unit of the all-wheel drive electric vehicle motor control system of FIG. 1A, in accordance with some embodiments.

FIG. 1D is a schematic diagram of an embodiment of the vehicle torque safety monitor of the vehicle control unit of FIG. 1C, in accordance with some embodiments.

FIG. 1E is a schematic diagram of one of the motor drive units of the all-wheel drive electric vehicle motor control system of FIG. 1A, in accordance with some embodiments.

FIG. 1F is a schematic diagram of a redundant torque safety monitor architecture, employing an instance of the vehicle torque safety monitor of FIG. 1C and multiple instances of the torque safety monitor of FIG. 1E, in accordance with some embodiments.

FIG. 2 is a schematic diagram of a torque safety monitor from the motor drive unit of FIG. 1E, in accordance with some embodiments.

FIG. 3 is a schematic diagram of a hardware protection unit from the motor drive unit of FIG. 1E, in accordance with some embodiments.

FIG. 4 is a flow diagram of a method of monitoring power in an all-wheel drive vehicle driven by electric motors, which can be practiced using the all-wheel drive electric vehicle motor control system unit of FIGS. 1A-1F, 2 and 3, in accordance with some embodiments.

### DETAILED DESCRIPTION

Generally, in electric motor control systems for electric and hybrid vehicles, a main motor controller sends pulse width modulation (PWM) control signals to a DC (direct current) to AC (alternating current) inverter. The DC/AC inverter then sends three-phase AC to an AC electric motor. The AC electric motor can be a permanent magnet AC motor, an induction motor, or one of other types of AC motors. Without limitation and for illustration purpose, an induction motor is given as an example load throughout the following illustration of the electric motor control system. In the present all-wheel drive electric vehicle motor control system, a vehicle control unit sends torque commands to each of two (or more) motor drive units. Each motor drive unit has a respective DC/AC inverter, which sends AC power to a respective electric motor. The vehicle control unit includes a vehicle torque safety monitor, which monitors vehicle power, i.e., mechanical power produced by the electric motors, energy storage system power, i.e., electrical power delivered from an energy storage system for conversion to mechanical power by the electric motors, and vehicle power commanded, i.e., the power that the vehicle control unit commands the electric motors to produce. Each of these is estimated and compared by the vehicle torque safety monitor, which reports inconsistencies. The commanded torque may be adjusted as a result of one or more inconsistencies.

In each of the motor drive units, a main motor controller sends the PWM control signals to a safety monitor. The safety monitor uses different control and measurement sensors than the main controller and runs code on a separate microcontroller, in some embodiments. The safety monitor has input from a torque command generator and the DC/AC inverter, in addition to the PWM control signals from the main motor controller. The safety monitor uses vehicle control information, including accelerator, brake, and vehicle speed, and motor information, including the rotational speed of the rotor, and the stator current. From all of this, the safety monitor derives the PWM control signals to send to the DC/AC inverter. As in previous electric motor control systems, the DC/AC inverter sends three-phase AC to the induction motor. A speed sensor coupled to the induction motor sends motor speed information to the main motor controller. The safety monitor thus protects against faults undetected by the main controller, and acts directly on controlling the inverter. Such faults include unintended vehicle acceleration, inverter malfunction, motor malfunction and speed sensor malfunctions. Since the main commands, in the form of the PWM control signals, go through the safety monitor, the safety monitor can correct for malfunctions in other parts of the system and issue corrected PWM control signals.

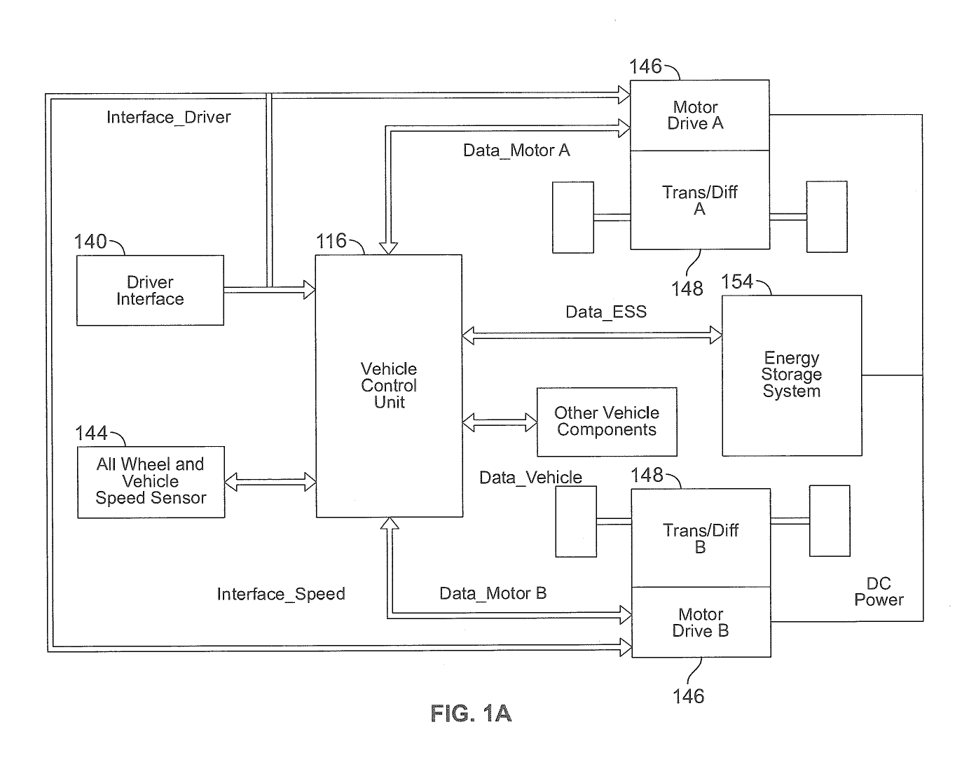

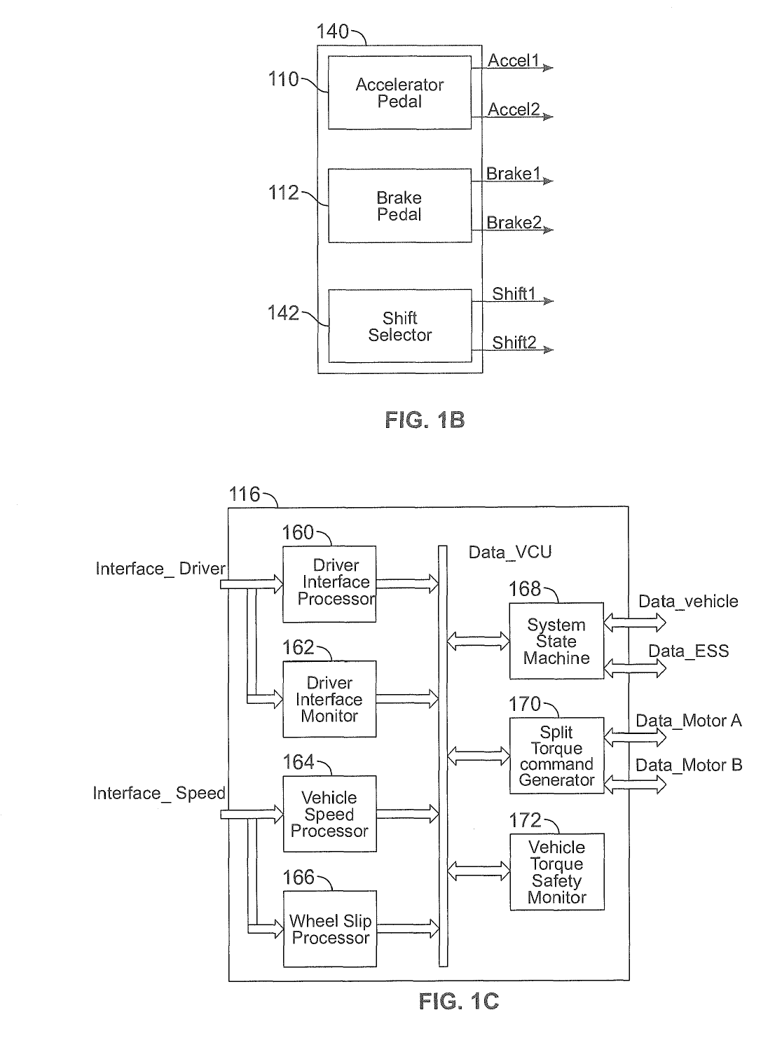

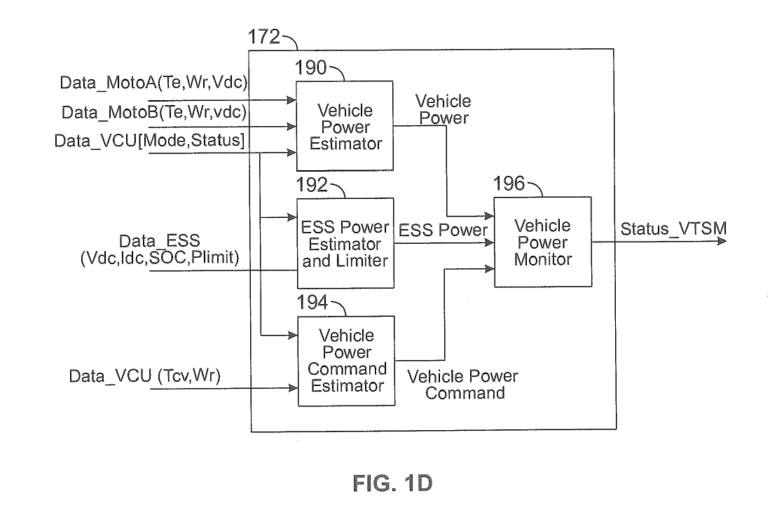

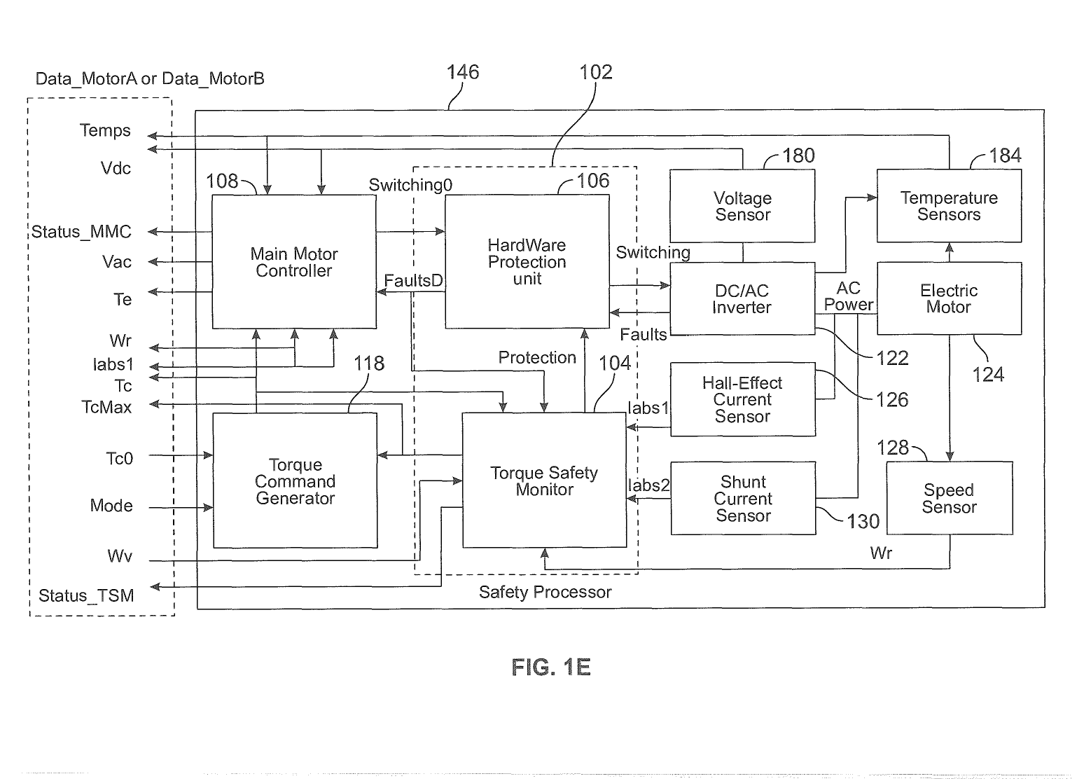

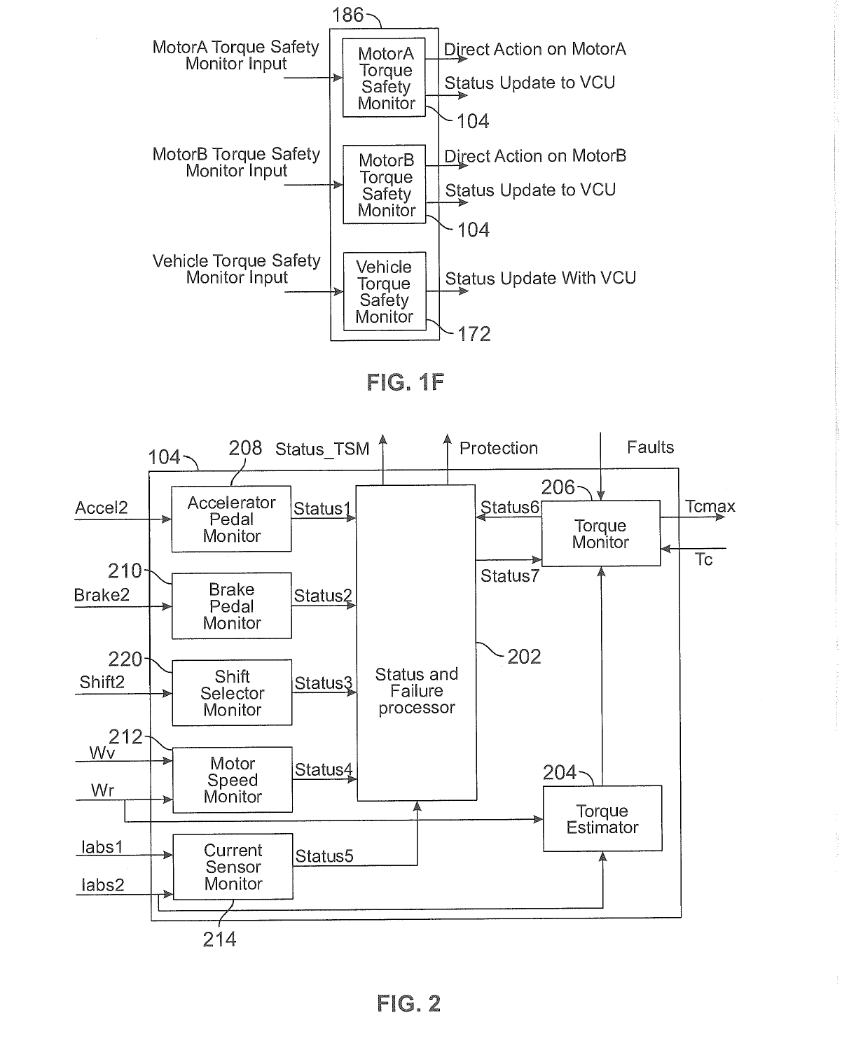

FIG. 1A is a schematic diagram of an all-wheel drive electric vehicle motor control system, with motor drive units 146, and corresponding electric motors, in accordance with the present disclosure. Various components of the all-wheel drive electric vehicle motor control system and motor drive units 146 can be implemented with one or more processors, hardware, and/or firmware, and combinations thereof. In the embodiment shown, a vehicle control unit 116 communicates with two motor drive units 146, a first one of which (labeled Motor Drive A) powers the front wheels of an all-wheel drive electric vehicle, and a second one of which (labeled Motor Drive B) powers the rear wheels of the all-wheel drive electric vehicle (or vice versa). Communication between the vehicle control unit 116 and the first motor drive unit 146 is handled via the Data_Motor A bus, which couples the vehicle control unit 116 and the first motor drive unit 146. Communication between the vehicle control unit 116 and the second motor drive unit 146 is handled via the Data_Motor B bus, which couples the vehicle control unit 116 and the second motor drive unit 146. Further embodiments of the all-wheel drive electric vehicle motor control system include a vehicle control unit 116 communicating with four motor drive units 146, one for each of the four wheels of the all-wheel drive electric vehicle, a vehicle control unit 116 communicating with three motor drive units 146, one for each of three wheels of an all-wheel drive electric vehicle (e.g., a tricycle platform with either a single front wheel and two rear wheels or a single rear wheel and two front wheels), a vehicle control unit 116 communicating with two motor drive units 146 of an all-wheel drive electric vehicle in the tricycle platform (e.g., a single front wheel or a single rear wheel is driven by one electric motor, and the remaining two wheels are driven by a second electric motor), and a vehicle control unit 116 communicating with three motor drive units 146, a first motor drive unit 146 for either the front two wheels or the rear two wheels (e.g., with a mechanical differential coupling these two wheels), a second motor drive unit 146 and a third motor drive unit 146 for each of the two remaining wheels. Further embodiments with various combinations of motor drive units 146 and wheels, and various drive platforms, are readily envisioned in accordance with the teachings disclosed herein. It should be appreciated that a hybrid vehicle could include an embodiment of the all-wheel drive electric vehicle motor control system, which would be applied to control and power all of the electric drive motors of such a vehicle.

As shown in FIG. 1A, the vehicle control unit 116 communicates with a driver interface 140 via the Interface_Driver bus, which includes a plurality of signals. The driver interface 140, which will be further discussed regarding FIG. 1B, receives inputs from the driver of the vehicle and communicates these inputs to the vehicle control unit 116. In addition to coupling the driver interface 140 and the vehicle control unit 116, the Interface_Driver bus also couples to each of the motor drive units 146.

The vehicle control unit 116 also communicates with the all-wheel and vehicle speed sensor 144, via the Interface_Speed bus, which provides information regarding wheel speeds and vehicle speed. In one embodiment, the all-wheel and vehicle speed sensor 144 includes a wheel rotation sensor at each wheel. For example, each wheel, disk brake at the wheel, or shaft driving the wheel could have a rotation speed transducer such as a shaft encoder, and the data from the rotation sensor could be sent via the Interface_Speed bus to the vehicle control unit 116. Various locations for a wheel speed sensor, and various types of wheel speed sensors, are readily devised in accordance with the teachings herein. In one embodiment, the all-wheel and vehicle speed sensor 144 calculates an average of all of the readings from the wheel speed sensors, and sends a vehicle speed data via the Interface_Speed bus to the vehicle control unit 116. In a further embodiment, the vehicle control unit 116 performs such a calculation from the readings from the wheel speed sensors. In a still further embodiment, a separate sensor of the all-wheel and vehicle speed sensor 144 measures vehicle speed, and provides data regarding the vehicle speed via the Interface_Speed bus to the vehicle control unit 116.

An energy storage system (ESS) 154 communicates with the vehicle control unit 116, via a Data_ESS bus. The vehicle control unit 116 can thus monitor the available electric power stored in the energy storage system 154, and make decisions regarding power to the electric motors, and vehicle speed, accordingly. In various embodiments, the energy storage system 154 includes electric batteries in various configurations, but could include one or more fuel cells, e.g., for hydrogen operation, or some other energy storage system such as a flywheel or thermal storage. The energy storage system 154 provides DC power to each of the motor drive units 146. In the embodiment shown, each of the motor drive units 146 powers two wheels through a transmission/differential unit 148. In further embodiments, e.g. versions of the tricycle platform, and the all-wheel drive vehicle with one electric motor per wheel, each motor drive unit 146 powers a respective single wheel, through a transmission, through a transfer case or via direct drive. Various couplings between electric motors and wheels are readily devised in accordance with the teachings herein.

Other vehicle components 156 communicate with the vehicle control unit 116, via a Data_Vehicle bus. Such components could include heater, ventilation and air-conditioning, brakes, windshield wipers and other electric accessories, tire pressure sensors, an accelerometer, a GPS (global positioning system) unit or other position sensor or navigation aid, and other components relating to vehicle operation. In one embodiment, a GPS unit is applied in making a determination of vehicle speed. The vehicle control unit 116 can use information from the other vehicle components 156 in making decisions as to electric power usage and safety, or can activate or deactivate other vehicle components 156 in response to various situations, in some embodiments.

FIG. 1B is a schematic diagram of the driver interface of the all-wheel drive electric vehicle motor control system of FIG. 1A. In the embodiment shown, the driver interface 140 includes an accelerator pedal assembly 110, a brake pedal assembly 112, and a shift selector assembly 142, each of which provides two versions of relevant signals to the Interface_Driver bus for redundancy. In further versions, each assembly could send a single version of a signal, or triple redundancy could be used. As shown, the accelerator pedal assembly 110 provides two versions of an accelerator parameter, Accel1 and Accel2. These can be generated by redundant position sensors attached to the accelerator pedal, or by other mechanisms as readily devised. As shown, the brake pedal assembly 112 provides two versions of a brake parameter, Brake1 and Brake2. These can be generated by redundant position sensors attached to the brake pedal, or by other mechanisms as readily devised. As shown, the shift selector assembly 142 provides two versions of a shift parameter, Shift1 and Shift2. These can be generated by redundant switches or position sensors attached to a shifter or a shifter linkage, or by other mechanisms as readily devised.

FIG. 1C is a schematic diagram of the vehicle control unit 116 of the all-wheel drive electric vehicle motor control system of FIG. 1A. Various components of the vehicle control unit 116 communicate with each other via a Data_VCU bus, and communicate with other components of the all-wheel drive electric vehicle motor control system via other busses. In the embodiment shown, a driver interface processor 160, a driver interface monitor 162, a vehicle speed processor 164, a wheel slip processor 166, a system state machine 168, a split torque command generator 170, and a vehicle torque safety monitor 172 communicate via the Data_VCU bus. In further embodiments, some of these could be combined with one another or moved outside of the vehicle control unit 116, or other components could be added to the vehicle control unit 116.

The driver interface 140 (see FIG. 1A) communicates with both the driver interface processor 160 and the driver interface monitor 162 (of FIG. 1C) via the Interface_Driver bus. In one embodiment, the driver interface processor 160 receives one version of the accelerator parameter Accel1 from the accelerator pedal assembly 110 of the driver interface 140, and the driver interface monitor 162 receives the other version of the accelerator parameter Accel2 from the accelerator pedal assembly 110. In a further embodiment, both the driver interface processor 160 and the driver interface monitor 162 receive both versions of the accelerator parameter. In one embodiment, the driver interface processor 160 receives one version of the brake parameter Brake1 from the brake pedal assembly 112 of the driver interface 140, and the driver interface monitor 162 receives the other version of the brake parameter Brake2 from the brake pedal assembly 112. In a further embodiment, both the driver interface processor 160 and the driver interface monitor 162 receive both versions of the brake parameter. In one embodiment, the driver interface processor 160 receives one version of the shift parameter Shift1 from the shift selector assembly 142 of the driver interface 140, and the driver interface monitor 162 receives the other version of the shift parameter Shift2 from the shift selector assembly 142. In a further embodiment, both the driver interface processor 160 and the driver interface monitor 162 receive both versions of the shift parameter. The driver interface processor 160 processes this information from the driver interface 140, and passes along the processed driver interface information to the system state machine 168, the split torque command generator 170, and the vehicle torque safety monitor 172. Processing of this information could include error correction, normalizing, scaling, offsetting, combining or other adjustments to the information.

The all-wheel and vehicle speed sensor 144 (of FIG. 1A) communicates with the vehicle speed processor 164 and the wheel slip processor 166 (of FIG. 1C) via the Interface_Speed bus. In various embodiments, the vehicle speed processor 164 calculates vehicle speed from readings from the wheel speed sensors of the all-wheel and vehicle speed sensor 144, or calculates the vehicle speed from a separate sensor of the all-wheel and vehicle speed sensor 144. In a further embodiment, the vehicle speed processor 164 performs both types of calculations, and compares the results, looking for differences indicative of an error or a problem. The vehicle speed processor 164 could pass along any of this information, in raw, converted or processed form, to the vehicle torque safety monitor 172 and could indicate errors or problems, or the vehicle torque safety monitor 172 could perform these types of calculations and detect errors or problems. In parallel with the vehicle speed processor 164 operations, the wheel slip processor 166 examines the readings from the wheel speed sensors of the all-wheel and vehicle speed sensor 144, and processes these to detect errors or problems, or passes along raw, converted or processed format data to the vehicle torque safety monitor 172. For example, the wheel slip processor 166 or the vehicle torque safety monitor 172 could look at wheel speeds and detect that one or more wheels are slipping with too much or too little rotation speed, locked up, or otherwise out of the norm for the vehicle as compared with the other wheels. Such a determination could be formed on the basis of wheel speed as a percentage of vehicle speed, e.g., normalized wheel speed. In one embodiment, the wheel slip processor 166 receives steering information, and takes into account the differing turning radii of wheels being steered (e.g., the front wheels in a front-wheel steering vehicle) versus the turning radii of the un-steered wheels (e.g., the rear wheels in a front-wheel steering vehicle). The wheel slip processor 166 can then calculate a vehicle speed, to be compared with the information from the vehicle speed processor 164, for example by the vehicle torque safety monitor 172, the vehicle speed processor 164 or the wheel slip processor 166. Four-wheel steering is accounted for by the wheel slip processor 166, in one embodiment.

The system state machine 168, as shown in FIG. 1C, communicates with the other vehicle components 156 (of FIG. 1A) via the Data_Vehicle bus, and communicates with the energy storage system 154 (of FIG. 1A) via the Data_ESS bus. In various embodiments, the system state machine 168 calculates or tracks overall energy availability and consumption, activates or deactivates components in accordance with overall energy availability and consumption, provides information to the split torque command generator 170 as to vehicle speed and estimated range, and provides information to the vehicle torque safety monitor 172 as to the energy availability and consumption.

The split torque command generator 170 processes information from each of the motor drive units 146 (see FIG. 1A), and sends commands to each of the motor drive units 146, via their respective busses Data_MotorA and Data_MotorB (and/or further busses for embodiments with further motor drive units 146). The split torque, i.e., the ratio of torque commanded to the front wheels versus to the rear wheels, or to each of a plurality of wheels in further embodiments, could be in accordance with a fixed ratio, a dynamically varying ratio, or a driver-settable ratio. For example, a fifty/fifty torque split could be commanded of the motor drive units 146, or the split could be seventy/thirty, i.e. seventy percent of the torque to the rear wheels and thirty percent of the torque to the front wheels, or other split. The torque split could vary depending upon detection of wheel slip, by the wheel slip processor 166, or could vary according to driver input via the driver interface 140 and the driver interface processor 160, e.g., a selection made by a selector or switches on the dashboard, or both. For example, the torque split could be at a generally fixed ratio but vary if the wheels slipped, or the torque split could the set as a percentage based upon a driver-adjustable setting such as dry weather, wet weather, snow and ice, racetrack, or predetermined ratios, or a continuously variable ratio, etc. Specifically, the torque split could be set by the driver and, if a wheel spins too rapidly in comparison to other wheels and steering input (if available in the embodiment), the split torque command generator 170 could reduce the commanded torque to the corresponding motor drive unit 146.

The vehicle torque safety monitor 172, as shown in FIG. 1C, communicates with other components of the vehicle control unit 116 via the Data_VCU bus. As the name of this component indicates, the vehicle torque safety monitor 172 is responsible for monitoring safety of the vehicle as relates to the torque of the motor drive units 146. Various embodiments of the vehicle torque safety monitor 172 implement one or more of the following examples of safety monitoring. The vehicle torque safety monitor 172 could monitor the interrelationships between two motors (or more, and further embodiments), looking for balance versus imbalance between the motors. If one electric motor is producing a large amount of torque, and one electric motor is producing very little torque, the vehicle torque safety monitor 172 security could issue a warning, e.g., to a dashboard display to alert the driver, or could direct the split torque command generator 170 to gradually reduce torque commanded to the motor drive units 146 in order to gradually slow the vehicle to a stop. This could prevent an unsafe condition that wouldn't necessarily be detected by just monitoring one motor. The vehicle torque safety monitor 172 could request that the split torque command generator 170 reduce torque to one of the motor drive units 146 in response to detection, by the wheel slip processor 166, of wheel slip. The vehicle torque safety monitor 172 could request that the split torque command generator 170 reduce torque to both (or all, or some combination) of the motor drive units 146 in response to detection, by the system state machine, of available energy being below a specified amount, or energy consumption exceeding a specified amount or rate, or a setting on the shift selector assembly 142 that is inconsistent with the vehicle speed as determined by the vehicle speed processor 164, e.g., a setting of “reverse” on the shift selector assembly 142 while the vehicle is moving forward at greater than a predetermined speed, or a forward setting on the shift selector assembly 142 while the vehicle is moving in reverse at greater than a predetermined speed. The vehicle torque safety monitor 172 could direct the split torque command generator 170 to adjust the torque split as communicated to the motor drive units 146, in response to detecting, from the information from the motor drive units 146, that the torque being produced by the electric motors is inconsistent with a commanded torque split. The vehicle torque safety monitor 172 could issue a warning or otherwise set an indication if the acceleration parameters, brake parameters, or shift parameters from the accelerator pedal assembly 110, brake pedal assembly 112, or shift selector assembly 142 have errors or show evidence of a failure. Under some of the above conditions, the vehicle torque safety monitor 172 could direct the split torque command generator 170 to reduce torque, shut off one of the motor drive units 146 or otherwise stop driving the associated electric motor, or shut off both of the motor drive units 146 or otherwise stop driving both of the electric motors.

FIG. 1D is a schematic diagram of an embodiment of the vehicle torque safety monitor 172 of the vehicle control unit 116 of FIG. 1C. In the embodiment shown, the vehicle torque safety monitor 172 includes a vehicle power estimator 190, an energy storage system power estimator and limiter 192, a vehicle power command estimator 194, and a vehicle power monitor 196. These components monitor power in differing ways, looking for inconsistencies and errors. A Status_VTSM (status of the vehicle torque safety monitor) output of the vehicle torque safety monitor 172 reports or otherwise indicates errors or inconsistencies, and can be used by the split torque command generator 170 of the vehicle control unit 116 (see FIG. 1C) to adjust overall torque or split torque as directed to the motor drive units 146. In some embodiments, the split torque command generator 170 makes decisions based upon Status_VTSM, and in some embodiments Status_VTSM directs adjustments of the split torque command generator 170.

The vehicle power estimator 190 receives estimated torque Te, rotational speed of the rotor Wr, and DC voltage Vdc from each of the motor drive units 146, via respective Data_Motor busses (e.g., A and B). The vehicle power estimator 190 also receives mode Mode and status Status parameters from the Data_VCU bus in the vehicle control unit 116 (see FIG. 1C). From these, the vehicle power estimator 190 calculates, derives or otherwise estimates total vehicle power as consumed or produced by the electric motors, and outputs this as the parameter Vehicle Power. For example, mechanical power of a motor is a product of torque and rotational speed, so the vehicle power estimator 190 can calculate mechanical power for each of a plurality of electrical motors and add the mechanical powers together to produce the total mechanical power produced by the electric motors. In one embodiment, this calculation takes into account the measured local DC bus voltage, applying the parameter Vdc.

The energy storage system (ESS) power estimator and limiter 192 receives parameters including the DC voltage Vdc, the DC current Idc, the state of charge SOC, and the battery discharge or charge power limit Plimit, from the energy storage system 154 via the Data_ESS bus (see FIG. 1A). From these, the ESS power estimator and limiter 192 calculates, derives or otherwise estimates electrical power being provided by the energy storage system 154, and outputs this as a parameter ESS Power. For example, electrical power can be calculated by multiplying the DC voltage and the DC current. This could include a discharge current in the case of the energy storage system 154 providing electrical power, or a charging current in the case of the energy storage system 154 being charged (i.e., under regenerative braking) In one embodiment, this calculation takes into account the estimated state of charge. In one embodiment, the energy storage system power estimator and limiter 192 calculates electrical power for each of the branches of power cabling, e.g. a first branch supplying electrical power to a first motor drive unit 146 and corresponding first electric motor, and a second branch supplying electrical power to a second motor drive unit 146 and corresponding second electric motor.

The vehicle power command estimator 194 receives parameters including the total commanded torque for the vehicle Tcv and the vehicle speed Wv from the Data_VCU bus in the vehicle control unit 116 (see FIG. 1C). For example, the vehicle power command estimator 194 could receive the vehicle speed from the vehicle speed processor 164, and could receive the total commanded torque for the vehicle from the split torque command generator 170, based upon the commanded torque Tc from each of the motor drive units 146. From these, the vehicle power command estimator 194 calculates, derives or otherwise estimates the total commanded vehicle power according to the motor drive units 146 and/or the split torque command generator 170, and outputs this as a parameter Vehicle Power Command. In one embodiment, the vehicle power command estimator 194 estimates commanded power to each of the motor drive units 146, and adds these values together to form the total commanded vehicle power. In one version, the vehicle power command estimator 194 takes into account the overall drive ratio, e.g., as determined by applying information from the shift selector assembly 142, in calculating the total commanded vehicle power. The vehicle power command estimator 194 could also derive a ratio of commanded power to each of the motor drive units 146, for comparison with a ratio of the mechanical power produced by each of the motor drive units 146.

The vehicle power monitor 196 receives the Vehicle Power parameter from the vehicle power estimator 190, the ESS power parameter from the ESS power estimator and limiter 192, and the Vehicle Power Command parameter from the vehicle power command estimator 194. In some embodiments, these parameters are affected by various modes and status data as available in the vehicle control unit 116. From these parameters, the vehicle power monitor 196 indicates, on the Status_VTSM output, whether the various power calculations are in agreement, i.e., are consistent with one another in accordance with expected values, ranges or ratios, or whether the various power calculations show inconsistencies, errors, discrepancies, disagreements, problems or other differences. In some embodiments, the vehicle power monitor 196 compares ratios of power, e.g. torque split ratio, ratios of mechanical power produced by two or more electric motors, and ratios of electrical power provided by the energy storage system to branches in power cabling. For example, the vehicle power monitor 196 could compare a ratio of first mechanical power to second mechanical power, a ratio of electrical power provided for production of the first mechanical power to the electrical power provided for production of the second mechanical power, and a ratio of the commanded vehicle power as commanded to the first electric motor to the commanded vehicle power as commanded to the second electric motor. In some embodiments, the vehicle power monitor 196 compares total amounts of power to sums of power as relate to two or more electric motors. Further variations of comparisons of total amount of power and ratios are readily devised in accordance with the teachings disclosed herein. Parameters could be declared consistent or in agreement if they are within, e.g., 2%, 10%, 20% or other percentage, ratio or range of each other, and inconsistent or having discrepancies if not within such a percentage, ratio or range of each other. It should be appreciated that comparisons of inverse ratios is equivalent to comparisons of ratios in this context, as the designation of “first” and “second” relative to the electric motors and related components is readily reassigned. It should be further appreciated that the embodiments having more than two electric motors can compare ratios, e.g., of the format a:b:c etc.

For example, if the ESS power parameter indicates much more power is being provided by the energy storage system 154 than is being produced by the electric motors, as the Vehicle Power parameter indicates, this could be seen as indicating a fault in the electrical systems such as a short in the wiring or a component, or other hazardous electrical discharge. The presumption would be, under regular and safe operation, most of the electrical power being provided by the energy storage system 154 is being converted to mechanical power by the electric motors. If the Vehicle Power Command parameter indicates much more power is being commanded than is being delivered by the electrical motors, as indicated by the Vehicle Power parameter, this could be seen as indicating a fault in one or more of the electrical motors. If the Vehicle Power parameter indicates much more power is being produced by the electric motors than is being commanded, as indicated by the Vehicle Power Command parameter, this could indicate a problem in the DC/AC inverter. If the estimated mechanical power produced by one electric motor and the estimated mechanical power produced by another electric motor are not in accordance with the torque split and commanded vehicle power as commanded to each of these two electric motors, this could indicate problems with the motors or the controllers. Any of the above situations could indicate sensor problems, communication errors, component failures, wiring failures or other situations. The magnitude of the discrepancy could indicate severity of the situation. Disagreement of one parameter while two parameters agree, versus disagreement of all three parameters, could also indicate severity of the situation. In some embodiments, parameters are saved in memory at regular intervals and/or in response to specific events, to later aid in troubleshooting.

FIG. 1E is a schematic diagram of one of the motor drive units 146 of the all-wheel drive electric vehicle motor control system of FIG. 1A. While shown in FIG. 1A as a portion of an all-wheel drive arrangement, the motor drive unit 146 may also be suitable for use in an electric vehicle having a single electric motor. As shown in FIG. 1E, a safety processor 102 interposes between a main motor controller 108 and a DC/AC inverter 122 in an electric vehicle motor control system. DC power to the DC/AC inverter 122 is provided by the energy storage system 154 (see FIG. 1A). Continuing with FIG. 1E, the safety processor 102 includes a torque safety monitor 104, which performs monitoring and directive functions, and a hardware protection unit 106, which modifies switching signals sent from the main motor controller 108 and destined for the DC/AC inverter 122. The torque safety monitor 104 and the hardware protection unit 106 are coupled to each other and cooperate to monitor various sensor values, conditions and other parameters of the motor and the vehicle, and decrease or turn off the AC power sent to the electric motor 124 in the event of certain problems. The torque safety monitor 104 receives a variety of status parameters and outputs system status information and a protection directive, based upon the status parameters. It should be appreciated that the torque safety monitor 104 monitors torque and other safety aspects of the electric motor to which the motor drive unit 146 is coupled, while the vehicle torque safety monitor 172 (of FIG. 1C) monitors torque and safety aspects of the plurality of electric motors associated with the vehicle.

Continuing with FIG. 1E, the hardware protection unit 106 is electrically interposed between the main motor controller 108 and the DC/AC inverter 122. The hardware protection unit 106 is configured to modify switching signals “Switching0” from the main motor controller 108, to “Switching” destined for the DC/AC inverter 122. The hardware protection unit 106 does so in response to the torque safety monitor 104 directing to decrease or shut down the AC power sent from the DC/AC inverter 122 to the electric motor 124. An overview of the electric vehicle motor control system is presented below, followed by a description of the safety processor 102.

The accelerator pedal assembly 110 and the brake pedal assembly 112 of the driver interface 140 provide control inputs Accel1, Brake1 to the vehicle control unit 116, as described above regarding FIGS. 1A-1C. The vehicle control unit 116, and particularly the split torque command generator 170 of the vehicle control unit 116, generates an initial commanded torque Tc0, which is sent to the torque command generator 118 via the Data_Motor (A or B) bus. From the initial commanded torque Tc0 and a maximum commanded torque Tcmax, which is treated as a torque upper limit, the torque command generator 118 generates a commanded torque Tc, which is input to the main motor controller 108. From the commanded torque Tc, a measured rotational speed Wr of the rotor of the electric motor 124 (an induction motor), and a first measured stator current Iabs1 of at least two phases of the electric motor 124, the main motor controller 108 generates switching signals Switching0. The main motor controller 108 also receives, in one embodiment, a DC voltage parameter Vdc from a voltage sensor 180 coupled to the DC/AC inverter 122, and a stator temperature Temps from temperature sensors 184 physically coupled to the electric motor 124. As an example of how the main motor controller 108 applies these parameters, the main motor controller 108 could modify the switching signals to the DC/AC inverter 122 in response to temperature and voltage information, either to compensate for reduced power resulting from increased temperature or decreased DC voltage available to the DC/AC inverter 122, or to reduce power output by the DC/AC inverter 122 when voltage or temperature are out of a predetermined range.

Were it not for the safety processor 102, the switching signals Switching0 would go directly to the DC/AC inverter 122, which would apply these signals to generate AC power for the electric motor 124 from the energy storage system 154 (supplying DC power to the motor drive unit 146). However, the safety processor 102 intercepts the switching signals Switching0. Particularly, the hardware protection unit 106 receives the switching signals Switching0 from the main motor controller 108, modifies them in accordance with a protection directive Protection from the torque safety monitor 104, and outputs the modified switching signals Switching to the DC/AC inverter 122. Additionally, the hardware protection unit 106 receives one or more fault parameters Faults from the DC/AC inverter 122, and outputs a fault status Faults0 to both the main motor controller 108 and the torque safety monitor 104.

As part of a safety system for an electric motor controller or a vehicle, the safety processor 102 can be implemented in various ways. In one embodiment, the torque safety monitor has a processor. The main motor controller also has a processor. The processor of the torque safety monitor 104 is distinct from the processor of the main motor controller. In another embodiment, the torque safety monitor 104 is distinct from the main motor controller 108 of the vehicle. The processor of the torque safety monitor 104 is configured to decrease or shut down the AC power that is sent from the DC/AC inverter 122 to the electric motor 124. It does so by sending the appropriate protection directive Protection to the hardware protection unit 106 when the estimated torque of the electric motor 124 differs from the commanded torque Tc by more than a set amount. The commanded torque Tc is associated with the main motor controller 108, as described above. The set amount could be a fixed constant, a variable dependent on motor speed, or a variable dependent upon vehicle speed, among other possibilities. In one embodiment, a predetermined delay is applied to the commanded torque Tc prior to comparing the commanded torque to the estimated torque, in order to compensate for the path delay of the estimated torque. Also, in one embodiment, the torque safety monitor 104 sends out a decreased maximum commanded torque Tcmax, in response to the estimated torque of the electric motor differing from the commanded torque by more than the set amount. The safety processor 102 could be implemented as an FPGA (field programmable gate array), or a PLD (programmable logic device), or could use a DSP (digital signal processor), a microcontroller or other processor to execute steps of a method.

A variety of parameters are monitored by the torque safety monitor 104 in the safety processor 102. The torque safety monitor receives a second set of control inputs Accel2, Brake2 from the accelerator pedal assembly 110 and the brake pedal assembly 112, via the Interface_Driver as shown in FIG. 1A. In one embodiment, the accelerator pedal assembly 110 uses two different sensors, the first of which provides the first acceleration parameter Accel1 to the vehicle control unit 116, the second of which provides the second acceleration parameter Accel2 to the torque safety monitor 104. In one embodiment, the brake pedal assembly 112 uses two different sensors, the first of which provides the first brake parameter Brake1 to the vehicle control unit 116 as shown in FIG. 1A, the second of which provides the second brake parameter Brake2 to the torque safety monitor 104. In further embodiments, these parameters are provided through separate wires, or separate buses, or use other forms of redundancy such that the torque safety monitor 104 can monitor accelerator and brake sensors and activity independently from the vehicle control unit 116.

The torque safety monitor also receives a vehicle speed Wv measurement from the vehicle speed processor 164 in one embodiment, or from the all-wheel and vehicle speed sensor 144, in a further embodiment. The vehicle speed Wv measurement could be from a wheel sensor or a combination of wheel sensors, a speedometer, a transmission or transaxle sensor etc. A speed sensor 128, coupled to the electric motor 124, provides a rotational speed Wr measurement of the rotor of the electric motor 124 to the torque safety monitor 104 and to the main motor controller 108. This could be from a sensor coupled to the rotor of the electric motor 124.

The torque safety monitor 104 receives two different measurements of the stator current Iabs1, Iabs2. In various embodiments, the measurements of the stator currents are provided by two sensors of different locations, or two sensors of differing types. In one embodiment, a first measurement of the stator current Iabs1 is provided by Hall-effect current sensors 126, and a second measurement of the stator current Iabs2 is provided by shunt current sensors 130. These various sensors could measure current on at least two phases of the stator. Using differing sensors, or even sensors of differing types, allows independent measurements of stator current to be compared in the torque safety monitor 104. Providing a measurement of the stator current to the torque safety monitor 104 allows the torque safety monitor 104 to measure aspects of the AC power provided to the electric motor 124 by the DC/AC inverter 122, and particularly allows the torque safety monitor 104 to estimate the torque produced by the electric motor 124.

FIG. 1F is a schematic diagram of a redundant torque safety monitor architecture 186, employing an instance of the vehicle torque safety monitor 172 of FIG. 1C and multiple instances of the torque safety monitor 104 of FIG. 1E. It should be appreciated that the redundant torque safety monitor architecture 186 includes a grouping of resources further described above and below, and can be implemented as a portion of the all-wheel drive electric vehicle motor control system of FIG. 1A. Each of the torque safety monitors 104 provides fast local detection and local reaction to failures in the respective motor drive units 146, e.g., A and B as shown in FIG. 1A. For example, the first torque safety monitor 104 (labeled MotorA) provides direct action on the first electric motor and a status update to the vehicle control unit 116, in response to events occurring or observed in the first motor drive unit 146, i.e., “A”. The second torque safety monitor 104 (labeled MotorB) provides direct action on the second electric motor and a status update to the vehicle control unit 116, in response to events occurring or observed in the second motor drive unit 146, i.e., “B”. The vehicle torque safety monitor 172 provides redundancy and overall monitoring of both motor drive units 146 and respective electric motors, and a status update to the vehicle control unit 116. In further embodiments with a greater number of electric motors, the redundant torque safety monitor architecture 186 includes a corresponding number of torque safety monitors 104. In some embodiments, the vehicle torque safety monitor 172 and each of the motor drive units 146 are implemented on differing components, e.g. with the vehicle torque safety monitor 172 implemented using a first processor, a first motor drive unit 146 implemented using a second processor, and a second motor drive unit 146 implemented using a third processor, to guard against all of these having a single point of failure.

FIG. 2 is a schematic diagram of a torque safety monitor 104 from the motor drive unit 146 of FIG. 1E, showing an embodiment of the torque safety monitor 104 in greater detail. In this embodiment, the torque safety monitor 104 includes a status and failure processor 202, a torque estimator 204, a torque monitor 206, an accelerator pedal monitor 208, a brake pedal monitor 210, a motor speed monitor 212, and a current sensor monitor 214. The torque estimator 204 produces an estimated torque Te from inputs including a measurement of a stator current Iabs2 of the electric motor 124 and the rotational speed Wr of the electric motor 124. In certain enhancements, one or more additional measured or estimated inputs may be beneficial for the torque estimator 204 to produce the estimated torque Te. As above, the electric motor 124 is controlled by the main motor controller 108, via the safety processor 102. In one embodiment, the torque estimator 204 includes a model of the electric motor 124. This could represent a steady state model or a dynamic model of torque based upon rotor speed and stator current. Embodiments could be lookup-table-based or real-time calculation-based.

The torque monitor 206 performs a comparison of the estimated torque Te and the commanded torque Tc, which are received by the torque monitor 206 as inputs. The torque monitor also receives the one or more fault parameters Faults from the DC/AC inverter 122, and interacts with the status and failure processor 202 by sending a status status6 to the status and failure processor 202 and receiving a status status7 from the status and failure processor 202.

In some embodiments, the torque monitor 206 sets the commanded maximum torque Tcmax to equal the commanded torque Tc if the commanded torque Tc and the estimated torque Te are close, and sets the commanded maximum torque Tcmax to the lesser of the two if these are very different. In performing this action, embodiments could use the commanded torque Tc or a delayed version of the commanded torque Tc. In one embodiment, the torque monitor sets the commanded maximum torque Tcmax equal to the present value of the commanded torque Tc in response to the estimated torque Te equaling the delayed commanded torque to within a specified amount. The torque monitor sets the commanded maximum torque Tcmax equal to the lesser of the estimated torque Te and the present value of the commanded torque Te in response to the estimated torque Te differing from the delayed commanded torque by more than the specified amount. This specified amount could be a fixed constant, or a variable dependent upon vehicle speed, motor speed or other parameters, in various embodiments. In further embodiments, the commanded maximum torque Tcmax could be decreased gradually, as a function of time, or set to an intermediate value.

The status and failure processor 202 is coupled to various monitors 208, 210, 212, 220, 214, as shown in FIG. 2. Each monitor receives a sensed value relating to the electric motor 124 or the vehicle, and communicates a status to the status and failure processor 202. The status and failure processor 202 outputs an aggregated status Status_TSM relating to the status of one or more of the monitors 206 208, 210, 212, 220, 214 and/or the faults of the DC/AC inverter 122 as relayed by the hardware protection unit and the fault status Faults0.

In some embodiments, the main motor controller 108 communicates status and fault information, based in part on the fault status Faults0, via a status Status_MMC to the vehicle control unit 116, more specifically to the split torque command generator 170 via the Data_Motor (A or B) as shown in FIGS. 1C and 1E. The vehicle control unit 116 could use the status Status_MMC from the main motor controller 108 and/or the status Status_TSM from the torque safety monitor 104, specifically from the status and failure processor 202, to produce warnings on a dashboard display or to reduce the commanded torque Tc0, in various embodiments. This could be accomplished by having the vehicle torque safety monitor 172 direct the split torque command generator 170 to reduce the commanded torque Tc0 to one or more of the motor drive units 146.

In addition to conveying the aggregated status Status_TSM, the status and failure processor 202 outputs the protection directive Protection, which is sent from the torque safety monitor 104 to the hardware protection unit 106. The protection directive Protection could be sent via a wire, multiple wires, a port or a bus, in various embodiments, and could have various formats as appropriate to the system design. The protection directive communicates that the status and failure processor 202 has determined there is a failure in one or more of the subsystems being monitored, and is directing the hardware protection unit 106 to reduce the power level associated with the switching signals for the DC/AC inverter 122 and accordingly reduce AC power sent to the electric motor 124.

The accelerator pedal monitor 208 receives a sensor value Accel2 from the accelerator pedal assembly 110 of the driver interface 140, as shown in FIGS. 1A, 1B and 2. In the embodiment shown, the sensor value Accel2 from the accelerator pedal assembly 110 is redundant with the sensor value Accel1 sent from the accelerator pedal assembly 110 to the vehicle control unit 116. In one embodiment, the sensor value Accel2 from the accelerator pedal assembly 110 includes power supply and ground information, e.g., on a bus, so that the accelerator pedal monitor 208 can detect a ground or power supply fault of the accelerator pedal assembly 110 in addition to monitoring activity or settings of the accelerator pedal assembly 110. Status is communicated via a status status1, which could be a signal line, a port or a bus, from the accelerator pedal monitor 208 to the status and failure processor 202.

The brake pedal monitor 210 receives a sensor value Brake2 from the brake pedal assembly 112 of the driver interface 140, as shown in FIGS. 1A, 1B and 2. In the embodiment shown, the sensor value Brake2 from the brake pedal assembly 112 is redundant with the sensor value Brake2 sent from the brake pedal assembly 112 to the vehicle control unit 116. In one embodiment, the sensor value Brake2 from the brake pedal assembly 112 includes power supply and ground information, e.g., on a bus, so that the accelerator pedal monitor 208 can detect a ground or power supply fault of the brake pedal assembly 112 in addition to monitoring activity or settings of the brake pedal assembly 112. Status is communicated via a status status2, which could be a signal line, a port or a bus, from the brake pedal monitor 210 to the status and failure processor 202.

The shift selector monitor 220 receives a shifter value Shift2 from the shift selector assembly 142 of the driver interface 140, shown in FIGS. 1A, 1B and 2. In the embodiment shown, the shifter value Shift2 from the shift selector assembly 142 is redundant with the shifter value Shift1 sent from the shift selector assembly 142 to the vehicle control unit 116. In one embodiment, the shifter value Shift2 from the shift selector assembly 142 includes power supply and ground information, e.g., on a bus, so that the shift selector monitor 220 can detect a ground or power supply fault of the shift selector assembly 142 in addition to monitoring activity or settings of the shift selector assembly 142. Status is communicated via a status status3, which could be a signal line, a port or a bus, from the shift selector monitor 220 to the status and failure processor 202.

The motor speed monitor 212 receives the vehicle speed value Wv from the vehicle speed processor 164 (see FIG. 1C), or directly from the all-wheel and vehicle speed sensor 144 (see FIG. 1A), and receives the rotational speed Wr of the electric motor 124 from the speed sensor 128, as shown in FIG. 1E. Applying an appropriate calculation, scaling one of these, or using a lookup table or other mechanism for adjusting the two parameters for comparison, the motor speed monitor 212 detects a discrepancy between the vehicle speed value Wv and the rotational speed Wr of the electric motor 124 exceeding a predetermined tolerance. In other words, if the vehicle speed and the rotational speed of the electric motor are inconsistent, i.e., out of tolerance with each other, the motor speed monitor 212 detects this.

In one embodiment, the motor speed monitor 212 can detect a ground or power supply fault in a vehicle speed sensor or a motor rotational speed sensor 128. In such an embodiment, the vehicle speed value Wv and the rotational speed Wr of the electric motor 124 could be supplied via buses and carry information about the power supply and ground connections as well as the requisite parameters. Status is communicated via a status status4, which could be a signal line, a port or a bus, from the motor speed monitor 212 to the status and failure processor 202.

The current sensor monitor 214 receives the two different measurements of the stator current Iabs1, Iabs2, and detects any discrepancy. A predetermined tolerance, and any scaling to allow for the differing types of sensors, could be applied in various embodiments. Status is communicated via a status status5, which could be a signal line, a port or a bus, from the current sensor monitor 214 to the status and failure processor 202.

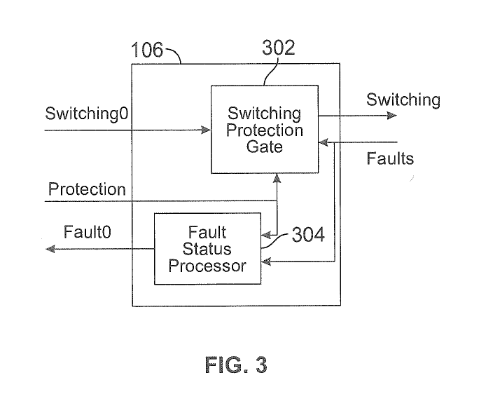

FIG. 3 is a schematic diagram of a hardware protection unit 106 from the motor drive unit 146 of FIG. 1E, showing an embodiment of the hardware protection unit 106 in greater detail. In this embodiment, the hardware protection unit 106 includes a switching protection gate 302 and a fault status processor 304. The fault status processor 304 receives the protection directive Protection from the torque safety monitor 104, and receives the one or more fault parameters Faults from the DC/AC inverter 122. The fault status processor 304 communicates aspects of these or information derived from these to the main motor controller 108, via the fault status Faults0, which could be a signal line, a port or a bus.

The switching protection gate 302 receives the switching signals Switching0 from the main motor controller 108, modifies these in accordance with the protection directive Protection, and outputs the modified switching signals “Switching” to the DC/AC inverter 122. In one embodiment, the switching signals “Switching0” are sent by the main motor controller 108 to direct pulse width modulation in the DC/AC inverter 122. The switching signals “Switching0” are modified by the switching protection gate 302 to produce the modified switching signals “Switching” that reduce the voltage and current amplitudes of the pulse width modulated AC power signals sent from the DC/AC inverter 122 to the electric motor 124, when so directed by the protection directive Protection. When the protection directive Protection directs to not modify the switching signals “Switching0,” i.e., when no fault is detected by the status and failure processor 202, the switching protection gate 302 passes through the switching signals Switching0 to the switching signals “Switching,” unmodified. Under circumstances of a major fault, the protection directive Protection directs the switching protection gate 302 to produce the modified switching signals “Switching” that cut power altogether to the electric motor 124. The modified switching signals “Switching” are produced by the switching protection gate 302 in a manner consistent with the specification of the DC/AC inverter 122, and may be design dependent.

In one embodiment, the switching protection gate 302 sets the modified switching signals Switching equal to the switching signals “Switching0” in response to the fault parameter Faults from the DC/AC inverter 122 indicating no fault in the DC/AC inverter 122, and the protection directive Protection indicating agreement between the estimated torque Te and the commanded torque Tc. The switching protection gate sets the modifying switching signals “Switching” to reduced power levels or an “off” state of the DC/AC inverter in response to the fault parameter Faults from the DC/AC inverter 122 indicating a fault in the DC/AC inverter 122, or the protection directive Protection indicating disagreement between the estimated torque Te and the commanded torque Tc.

By employing connections to modules both upstream and downstream of the main motor controller 108, the safety processor 102 can safeguard processes and protect against failures in various locations throughout the motor control system. For example, the connections from the safety processor 102 to the vehicle control unit 116 and the torque command generator 118 can be used to cut the commanded torque Tc, which is an input to the main motor controller 108. Cutting the commanded torque Tc then results in the main motor controller 108 reducing the AC power (to the electric motor 124) called for by the switching signals “Switching0.” On the other hand, the connections from the status and failure processor 202 to the switching protection gate 302 can be used to much more immediately cut the AC power called for by the switching signals “Switching0,” by reducing the AC power called for by the modified switching signals “Switching” without waiting for the effects of the reduced commanded torque Tc to ripple through the main motor controller 108. This multiple-layered safety approach has aspects of fault tolerance and graceful system degradation, which are advantageously applied to benefit the user of a motor control system.

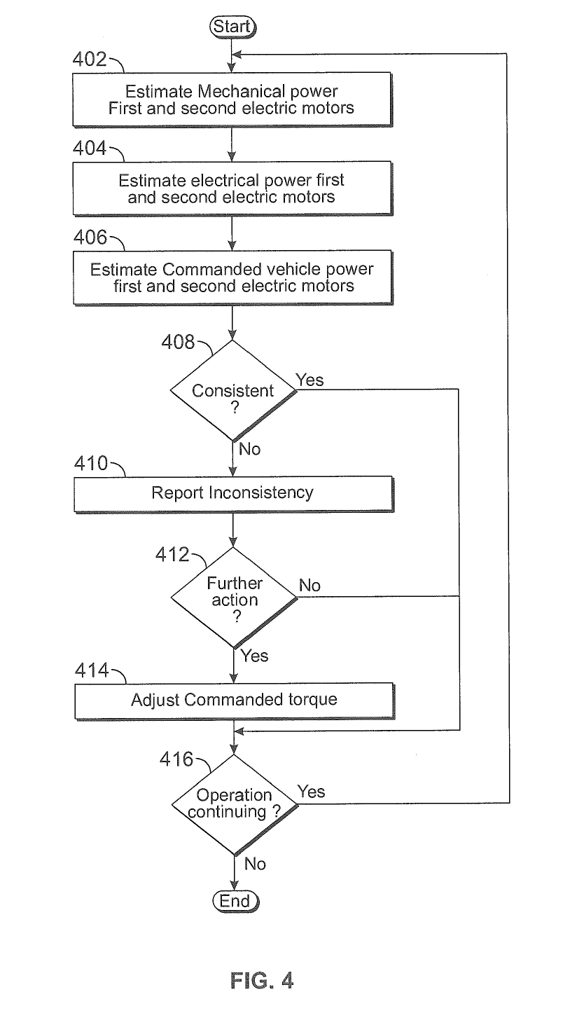

FIG. 4 is a flow diagram of a method of monitoring power in an all-wheel drive vehicle driven by electric motors, which can be practiced using the all-wheel drive electric vehicle motor control system unit of FIGS. 1A-1F, 2 and 3, and embodiments thereof. The method can be embodied using various types of processors, including one or more microcontrollers or DSPs, or logic as implemented on an FPGA or PLD. Examples of how actions of the method can be implemented are given below.

From a start point, mechanical power of the first and second electric motors is estimated, in an action 402. For example, the vehicle power estimator of the vehicle torque safety monitor could estimate mechanical power for each of the two electric motors (or further electric motors, in various embodiments), and add the results together to estimate the total mechanical power produced by the two electric motors at the time of determination of various parameters.

The electrical power of the first and second electric motors is estimated, in an action 404. For example, the energy storage system power estimator and limiter could calculate the electric power being delivered from the energy storage system, by multiplying a DC voltage and a DC current together. In some embodiments, the electric power could be calculated as delivered to each of the two motor drive units and corresponding electric motors, for example by multiplying a DC voltage and a DC current of each of two branches from the energy storage system, with one branch being delivered to one drive unit and motor, and the other branch being delivered to the other drive unit and motor.

The commanded vehicle power, as commanded to the first and second electric motors, is estimated in an action 406. For example, the vehicle power command estimator could estimate power commanded to each of two motor drive units and corresponding electric motors, in cooperation with either a split torque command generator or each of the motor drive units. The results could then be added together to form the total commanded vehicle power. Flow continues to the decision action 408.

In the decision action 408, the question is asked, are the results of the estimates consistent? One estimate differing from the other two, or all three estimates differing, would constitute inconsistent results. Various ranges, ratios, predetermined values, predetermined tolerances and so on could be applied in a determination of an answer to this question. Ratios of power as applied to each of the first and second motors could be compared (i.e., power as applied to one motor versus power as applied to the other motor), as could total power (i.e., the combined power as applied to both motors).

If the answer to the decision action 408 is yes, the results of the estimates are consistent, flow branches to the decision action 416 to ask if the operation is continuing. If the answer to the decision action 408 is no, the results of the estimates are not consistent, flow branches to the action 410. In the action 410, the inconsistency is reported. This could take the form of a status variable or a message. Flow continues to the decision action 412.

In a decision action 412, the question is asked, is there further action? If the answer is no, there is no further action (after reporting the inconsistency), flow branches to the decision action 416 to ask if the operation is continuing. If the answer is yes, there should be further action, flow branches to the action 414. In the action 414, the commanded torque is adjusted. This could be implemented by having the vehicle power monitor issue a direction to reduce, increase or otherwise adjust the overall torque or reduce, increase or otherwise adjust the torque of one, the other or both electric motors. The split torque command generator or each of the motor drive units could then carry out this direction. This could also be implemented by having the vehicle power monitor issue the status variable or the message as above, which the split torque command generator or each of the motor drive units could then interpret. The split torque command generator or each of the motor drive units could then make decisions as to torque of the electric motors. In one embodiment, issuing such a direction acts as a report of the inconsistency, so that the actions 408, 410, 412, 414 are compressed into one action of issuing the direction. Flow continues to the decision action 416.

In the decision action 416, the question is asked, is the operation continuing? If the answer is no, the operation is not continuing, the flow branches to an endpoint, or elsewhere in further embodiments. If the answer is yes, the operation is continuing, the flow branches back to the action 402, in order to continue monitoring. In further embodiments, other branchings could take place, or some actions could take place in parallel with other actions or in differing orders, etc.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The embodiments can also be embodied as computer readable code on a computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A vehicle torque safety monitor, comprising:
a vehicle power estimator configured to estimate a first mechanical power of a first electric motor and a second mechanical power of a second electric motor;
an energy storage system power estimator and limiter, configured to estimate electrical power provided by an energy storage system, at least a portion of the electrical power converting to the first mechanical power and the second mechanical power; and
a vehicle power monitor, configured to indicate an inconsistency in the first mechanical power, the second mechanical power, and the electrical power.

2. The vehicle torque safety monitor of claim 1, further comprising:
a vehicle power command estimator, configured to estimate commanded vehicle power as commanded to the first electric motor and the second electric motor; and
the vehicle power monitor, further configured to indicate an inconsistency among the first mechanical power, the second mechanical power, the electrical power, and the commanded vehicle power.

3. The vehicle torque safety monitor of claim 1, further comprising:
the vehicle power estimator configured to receive a first estimated torque and a first estimated rotational speed of the first electric motor, and a second estimated torque and a second estimated rotational speed of the second electric motor, wherein an estimate of the first mechanical power is based upon the first estimated torque and the first estimated rotational speed, and wherein an estimate of the second mechanical power is based upon the second estimated torque and the second estimated rotational speed.

4. The vehicle torque safety monitor of claim 1, further comprising:
the energy storage system power estimator and limiter configured to receive a DC voltage parameter and a DC current parameter from an energy storage system, wherein an estimate of the electrical power is based upon the DC voltage parameter and the DC current parameter.

5. The vehicle torque safety monitor of claim 1, wherein:
the vehicle power estimator is configured to couple to a first motor drive unit and a second motor drive unit;
the energy storage system power estimator and limiter is configured to couple to the energy storage system; and
the vehicle power monitor is configured to couple to at least one monitor or processor of a vehicle control unit.

6. The vehicle torque safety monitor of claim 1, wherein:
the vehicle power estimator is configured to provide a vehicle power parameter to the vehicle power monitor;
the energy storage system power estimator and limiter is configured to provide an energy storage system power parameter to the vehicle power monitor; and
the vehicle power monitor is configured to provide a status parameter to or in a vehicle control unit.

7. The vehicle torque safety monitor of claim 1, further comprising:
the vehicle power monitor configured to couple to one of a split torque command generator or a torque command generator, and to cooperate therewith to adjust a commanded torque in response to the inconsistency.

8. A vehicle control unit, comprising:
a split torque command generator configured to couple to a first electric motor and to a second electric motor, the first electric motor and the second electric motor providing motive power for an all-wheel drive vehicle, the split torque command generator configured to direct the first electric motor to produce a first torque and direct the second electric motor to produce a second torque; and
a vehicle torque safety monitor coupled to the split torque command generator, the vehicle torque safety monitor configured to:
estimate mechanical power produced by each of the first electric motor and the second electric motor;
estimate electrical power provided for conversion to mechanical power by the first electric motor and the second electric motor; and
cooperate with the split torque command generator to alter at least one of the first torque and the second torque, in response to a discrepancy in the mechanical power and the electrical power.

9. The vehicle control unit of claim 8, wherein altering at least one of the first torque and the second torque includes directing the first electric motor to produce a first reduced torque or directing the second electric motor to produce a second reduced torque.

10. The vehicle control unit of claim 8, further comprising:
a first torque safety monitor coupled to the split torque command generator and configured to couple to the first electric motor, the first torque safety monitor configured to decrease AC (alternating current) electrical power sent to the first electric motor in response to an estimated torque of the first electric motor differing from a commanded torque of the first electric motor by more than a first set amount; and
a second torque safety monitor coupled to the split torque command generator and configured to couple to the second electric motor, the second torque safety monitor configured to decrease AC (alternating current) electrical power sent to the second electric motor in response to an estimated torque of the second electric motor differing from a commanded torque of the second electric motor by more than a second set amount.

11. The vehicle control unit of claim 8, wherein the discrepancy includes a discrepancy between the electrical power and a sum of the mechanical power produced by the first electric motor and the mechanical power produced by the second electric motor.

12. The vehicle control unit of claim 8, wherein the vehicle torque safety monitor is further configured to:
estimate a total commanded vehicle power; and
cooperate with the split torque command generator to alter the at least one of the first torque and the second torque, in response to a discrepancy between the total commanded vehicle power and at least one of the mechanical power and the electrical power.

13. A method for monitoring power in an all-wheel drive vehicle having a plurality of electric motors, the method comprising:
calculating a first mechanical power produced by a first electric motor of the all-wheel drive vehicle;
calculating a second mechanical power produced by a second electric motor of the all-wheel drive vehicle;
calculating electrical power provided for production of the first mechanical power and the second mechanical power;
calculating commanded vehicle power, as commanded to the first electric motor and the second electric motor; and
determining whether the first mechanical power, the second mechanical power, the electrical power, and the commanded vehicle power are consistent; and
reporting an inconsistency, in response to determining the inconsistency among the first mechanical power, the second mechanical power, the electrical power, and the commanded vehicle power, wherein at least one step of the method is performed by a processor.

14. The method of claim 13, wherein:
calculating the first mechanical power includes multiplying an estimated torque of the first electric motor by a rotational speed of the first electric motor; and
calculating the second mechanical power includes multiplying an estimated torque of the second electric motor by a rotational speed of the second electric motor.

15. The method of claim 13, wherein calculating the electrical power includes multiplying a DC (direct current) voltage by a DC current.

16. The method of claim 13, wherein calculating the electrical power includes multiplying a DC (direct current) voltage by a DC current, for each of a first branch providing a first electrical power for the first electric motor and a second branch providing a second electrical power for the second electric motor.

17. The method of claim 13, wherein calculating commanded vehicle power includes adding a first commanded torque from a first motor drive unit coupled to the first electric motor, and a second commanded torque from a second motor drive unit coupled to the second electric motor.

18. The method of claim 13, wherein determining whether the first mechanical power, the second mechanical power, the electrical power, and the commanded vehicle power are consistent includes the electrical power, the commanded vehicle power, and a sum of the first mechanical power and the second mechanical power being in agreement to within one of: a predetermined range or a predetermined ratio.

19. The method of claim 13, wherein the inconsistency includes disagreement among any two of:
the electrical power;
the commanded vehicle power; and
a sum of the first mechanical power and the second mechanical power.

20. The method of claim 13, wherein the inconsistency includes disagreement among any two of:
a ratio of (a) the first mechanical power to (b) the second mechanical power;
a ratio of (c) a first electrical power provided for production of the first mechanical power to (d) a second electrical power provided for production of the second mechanical power; and
a ratio of (e) the commanded vehicle power, as commanded to the first electric motor, to (f) the commanded vehicle power, as commanded to the second electric motor.
